(19) United States
(12) Patent Application Publication
(10) Pub. No.: US 2008/0048412 A1
(43) Pub. Date: Feb. 28, 2008

(54) Pedal-Powered Vehicle

(75) Inventor: Itay Dror, Holon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: A.T.D. - Airwalking Technologies & Development Ltd., Holon (IL)

(21) Appl. No.: 11/466,121

(22) Filed: Aug. 22, 2006

(51) Int. Cl. B62K 7/00

(52) U.S. Cl. 280/288.3

(57) ABSTRACT

When combined in a two-wheel pedal powered scooter, the features of the present invention provide a vehicle that is small and compact. The reciprocating pedals allow for a low center of gravity since there is no need to allow for the full turn of regular pedals The incorporation of a shiftable transmission in the scooter body provides the rider with speed when appropriate and power when needed, while eliminating the need for a large front sprockets Since the drive mechanism is substantially fully enclosed by the body of the scooter, there is less of a problem with dirt and debris disturbing the operation of the drive mechanism. The unique steering column provides hidden cables and adjustable steering column angle, among other features

### FIELD AND BACKGROUND OF THE INVENTION

The present invention relates to pedal-powered vehicles and, in particular, it concerns a pedal-powered vehicle having two reciprocating pedals that are used to power the vehicle by either using both pedals cooperatively or each pedal separately.

Two wheeled vehicles powered by pedals are known in the art in a variety of forms, from bicycles to several kinds of scooters.

A variety of pedaling methods have been implemented with regard to scooters One croup of pedal-powered scooters, as represented by U.S. Pat. No. 1,237,969, employs a rocking horizontal plate that is longitudinally deployed on the scooter to serve as the pedal Therefore, the pedal is operated by stepping alternately on the front and back regions of the pedal. This manner of standing, one leg behind the other, is relatively unstable for the rider and does not enable efficient application of power to the pedals, since it requires shifting body weight contrary to the forward inertia of the scooter.

Another group of scooters employs the chain and sprocket drive mechanism transferred from bicycles. By necessity, this drive system requires a large front sprocket, which dictates the size of the scooter. Therefore, these scooters are generally large.

Still another group of scooters, such as disclosed in U.S. Pat. No. 4,379,566, attempts to overcome the inertia problem discussed above by employing a pair of pedals in which the power stroke of the pedal is toward the rear of the scooter The scooters of this group that employ the standard bicycle chain drive still suffer from the issue of large size.

In an attempt to address the size issue, some scooters, such as the one described in U.S. Pat. No. 4,761,014, employ a geared transmission. This serves to reduce the overall size of the scooter However, the scooter of U.S. Pat. No, 4,761,014 uses only one pedal to provide locomotive power for the scooter. This does not utilize the power of the rider to its fullest since only one leg can be used to power the scooter.

There is therefore a need for a pedal-powered vehicle having two reciprocating pedals that are used to power the vehicle by either using both pedals cooperatively or each pedal separately and which employs a geared transmission to deliver driving power to the drive wheel. It would be of benefit if the vehicle body were configured such that the transmission assembly is integral to the body.

### SUMMARY OF THE INVENTION

The present invention is a pedal-powered vehicle having two reciprocating pedals that are used to power the vehicle by either using both pedals cooperatively or each pedal separately.

According to the teachings of the present invention there is provided, A pedal-powered vehicle comprising a molded body having at least one molded attachment arrangement such that the at least one molded attachment arrangement is integrally molded in the molded body, the attachment mechanism configured for the attachment of at least one vehicle component.

According to a further teaching of the present invention, the molded body is configured as two molded sections that attach one to another.

According to a further teaching of the present invention, the vehicle component is a geared transmission having gear-shaft bearings, the geared transmission configured to transmit power from vehicle pedals to a vehicle drive-wheel, and the at least one integrally formed attachment arrangement includes at least one socket integrally formed in each of the two molded sections, the sockets configured to receive the gear-shaft bearings.

According to a further teaching of the present invention, there is also provided at lease one reciprocating drive pedal configured to supply power to the geared transmission.

According to a further teaching of the present invention, the at least one reciprocating drive pedal is configured as two reciprocating drive pedals, such that either both pedals cooperatively or each pedal separately supplies power to the geared transmission.

According to a further teaching of the present invention, the vehicle component is a drive-wheel axle, and the at least one integrally formed attachment arrangement includes at least one adjustable axle mount configured to adjust a position of the axle and thereby adjust tension of a drive chain supplying power to the drive-wheel.

According, to a further teaching of the present invention, there is also provided a metal reinforcement element deployed within and fixedly attached to the molded body.

According to a further teaching of the present invention, the metal reinforcement element includes a head tube configured to accept a steering column, thereby reinforcing the attachment of the steering column to the body.

According to a further teaching of the present invention, there is also provided a position adjustable rear brake element adjustably attached to the body, a position of the position adjustable rear brake element being adjustable in relation to a vehicle rear wheel.

According, to a further teaching of the present invention, there is also provided at lease one reciprocating drive pedal configured to supply power to a vehicle drive-wheel.

According to a further teaching of the present invention, there is also provided a kickstand displaceable between a vehicle support position and a pedal down-stroke stop position.

There is also provided according to the teachings of the present invention, a pedal-powered vehicle comprising a molded body configured with an interior volume in which is housed a power transmission gear-cluster, and the molded body and the power transmission gear-cluster are both configured for direct attachment of the power transmission gear-cluster to the molded body, thereby eliminating a separate power-transmission casings.

According to a further teaching of the present invention, the molded body includes a plurality of sockets integrally formed within the molded body, the sockets configured to receive gear-shaft bearings of the power transmission gear-cluster.

According to a further teaching of the present invention, the power transmission gear-cluster includes a gear chance mechanism so as to provide shiftable multi-speed gearing.

There is also provided according to the teachings of the present invention, a steering column capable of adjusting an angle of alignment between a longitudinal axis of the steering column, and a longitudinal axis of a head tube supporting a portion of the steering column, the steering column comprising: a) a lower section deployed within the head tube such that a longitudinal axis of the lower section is substantially parallel to the longitudinal axis of the head tube; b) an upper section rotatably interconnected to the lower section, the rotation being about an axis that is substantially perpendicular to the longitudinal axis of the steering column, thereby allowing adjustment of an angle of alignment between the upper section and the lower section, and thereby an angle of alignment between the upper section and the head tube; and c) a locking mechanism configured to lock rotation of interconnection of the upper steering section to the lower steering section so as to maintain a desired angle of alignment.

According to a further teaching of the present invention, the locking mechanism includes: a) a slideable positioning element deployed on the upper steering, section; b) a locking catch deployed on the lower steering section; and c) a locking lever attached to the slideable positioning element and configured for releasable attachment to the locking catch; wherein varying a distance between the slideable positioning element and the locking catch varies the angle of alignment between the upper section and the head tube when the locking lever is attached to the locking, catch.

There is also provided according to the teachings of the present invention, a combination vehicle support and pedal down-stroke stop for use with a reciprocating-pedal powered vehicle, the combination vehicle support and pedal down-stroke stop comprising a vehicle support structure attached to a vehicle body so as to be displaceable between a vehicle support position, in which the reciprocating-pedal powered vehicle is at least partially supported while at rest, and a pedal down-stroke stop position, which defines an end point of a down-stroke motion of at least one reciprocating-pedal.

According to a further teaching of the present invention, the vehicle support structure includes at least one cushioned pedal-stop element that extends beyond a lateral side of the vehicle body.

According to a further teaching of the present invention, the vehicle support structure includes two cushioned pedal-stop elements such that each the cushioned pedal-stop element extends beyond a different lateral side of the vehicle body so as to block the down-stroke motion of two reciprocating-pedals.

There is also provided according to the teachings of the present invention, a reciprocating pedal-arm assembly comprising; a) a crank shaft; b) a pedal arm having a pedal end and crank end, the pedal end having at least one through bore for attachment of a pedal, and the crank end having a through bore configured for through passage of at least an end portion of the crank shaft; c) a ratchet mechanism deployed within a ratchet housing, the ratchet housing attached to the pedal arm such that the end portion of the crank shaft engages the ratchet mechanism; wherein the pedal arm and the ratchet housing rotate about the crank shaft and the ratchet housing is constructed from a material harder than the pedal arm.

According to a further teaching of the present invention, the pedal arm is constructed from at least one of the materials chosen from a list including polymers, molded plastics, fiber reinforced plastics, carbon fiber composites, aluminum, and light metal alloys, and the ratchet housing is constructed from at least one of the materials chosen from a list including cast iron and steel.

According to a further teaching of the present invention, the cranic end of the pedal arm is configured to receive at least one bearing assembly such that the crank shaft passes through the at least one bearing assembly and the pedal arm is supported on the crank shaft by the bearing assembly.

According to a further teaching of the present invention, there is also provided at least one flat spiral spring configured to bias the pedal arm toward an upraised pedal home position.

According to a further teaching of the present invention, the at least one flat spiral spring has two attachment tabs, one configured at each end of the flat spiral spring and each the attachment tab extends laterally from an opposite side of the flat spiral spring.

There is also provided according to the teachings of the present invention, a steering column assembly comprising: a) a substantially hollow steering-column tube that is open at both top and bottom ends with an open passageway therebetween, the steering-column tube having an internal cross-sectional contour; b) a handlebar attachment element for rigidly attaching handlebars to the steering-column tube, the handlebar attachment configured to circumscribe at least an attachment region of the steering-column tube and tighten there around; and c) a reinforcing element having an external cross-sectional contour substantially equivalent to the internal cross sectional contour of the steering-column tube, the reinforcing element deployed inside the steering-column tube so as to internally correspond to the attachment region such that the attachment region is positioned between the reinforcing element and the handlebar attachment element so as to provided support to the portion of the steering column tube when the handlebar attachment element is tightened there around while allowing the open passageway to remain open.

According to a further teaching of the present invention, the reinforcing element is constructed from a material harder than the steering column tube.

According to a further teaching of the present invention, the steering column tube is constructed from at least one material chosen from a list including fiber reinforced polymers, carbon fiber composites, aluminum, and light metal alloys, and the reinforcing, element is constructed from at least one of the materials chosen from a list including cast iron and steel.

According to a further teaching of the present invention, a length of at least one accessory cable passes through the open passageway.

According to a further teaching of the present invention, the at least one accessory cable passes through a through bore configured in a side wall of the steering column tube in proximity to the bottom end of the steering column tube.

According to a further teaching of the present invention, the at least one accessory cable passes through a through bore configured in a body panel of a vehicle to which the steering column assembly is attached.

### BRIEF DESCRIPTION OF THE DRAWINGS

The invention is herein described, by way of example only, with reference to the accompanying drawings, wherein:

FIG. 1 is an isometric view of a preferred embodiment of a two-wheel scooter constructed and operative according to the teachings of the present invention, with the area of the body panel adjacent to the internal transmission cut away in order to show the transmission;

FIG. 2 is an exploded isometric bottom view of a preferred embodiment of a reciprocating pedal assembly constructed and operative according to the teachings of the present invention;

FIG. 2A is an exploded isometric top view of the reciprocating pedal assembly of FIG. 2;

FIGS. 2B-2D are exploded isometric details of the pedal arm and ratchet assembly of the embodiment of FIG. 2;

FIG. 3 is an exploded isometric top view of a preferred embodiment of a molded body constructed and operative according to the teachings of the present invention;

FIGS. 3A and 3B are exploded isometric bottom views of the embodiment of FIG. 3;

FIG. 4 is an isometric top view of a preferred embodiment of a transmission constructed and operative according to the teachings of the present invention;

FIG. 4A is an exploded isometric top view of the transmission of FIG. 4; also showing a the gear-shifter mechanism;

FIGS. 4B and 4C are exploded isometric views of the gear-shifter mechanism of the transmission of FIG. 4;

FIG. 5 is an isometric view of the embodiment of FIG. 1, shown here with a side body panel removed and showing the path of the cables through the body;

FIG. 6 is an exploded isometric view of the front fork and front brake assembly of the embodiment of FIG. 1;

FIGS. 7-7B is an exploded isometric view of the rear wheel and rear fender/brake assembly of the embodiment of FIG. 1;

FIGS. 8 and 8A are isometric details of the handlebar assembly of the embodiment of FIG. 1;

FIGS. 9 and 9A are exploded isometric views of the steering column of the embodiment of FIG. 1;

FIGS. 9B and 9C are isometric views showing folding of the steering column of the embodiment of FIG. 1;

FIG. 10 is an exploded isometric bottom view of the kickstand of the embodiment of FIG. 1;

FIG. 10A is a side elevation of the embodiment of FIG. 1 showing the two different positions of the kickstand; and

FIG. 10B is a cross-sectional detail of FIG. 10A.

### DESCRIPTION OF THE PREFERRED EMBODIMENTS

The present invention is a pedal-powered vehicle having two reciprocating pedals that are used to power the vehicle by either using both pedals cooperatively or each pedal separately.

The principles and operation of pedal-powered vehicles according to the present invention may be better understood with reference to the drawings and the accompanying description.

By way of introduction, the vehicle of the present invention includes a number of features that will be discussed individually and collectively with regard to the embodiment illustrated in the figures, which is a two-wheel pedal powered scooter. It will be appreciated that some, if not all of the features of the present invention may be used to benefit other vehicles such as pedal and motor powered vehicles and those having substantially any number of wheels.

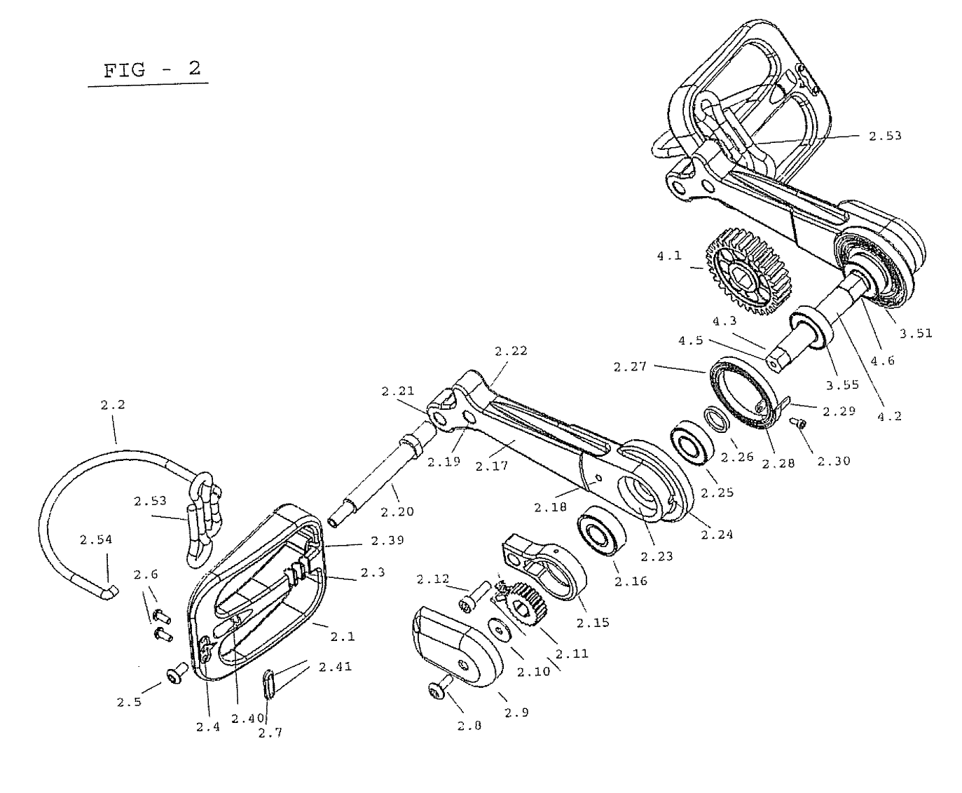

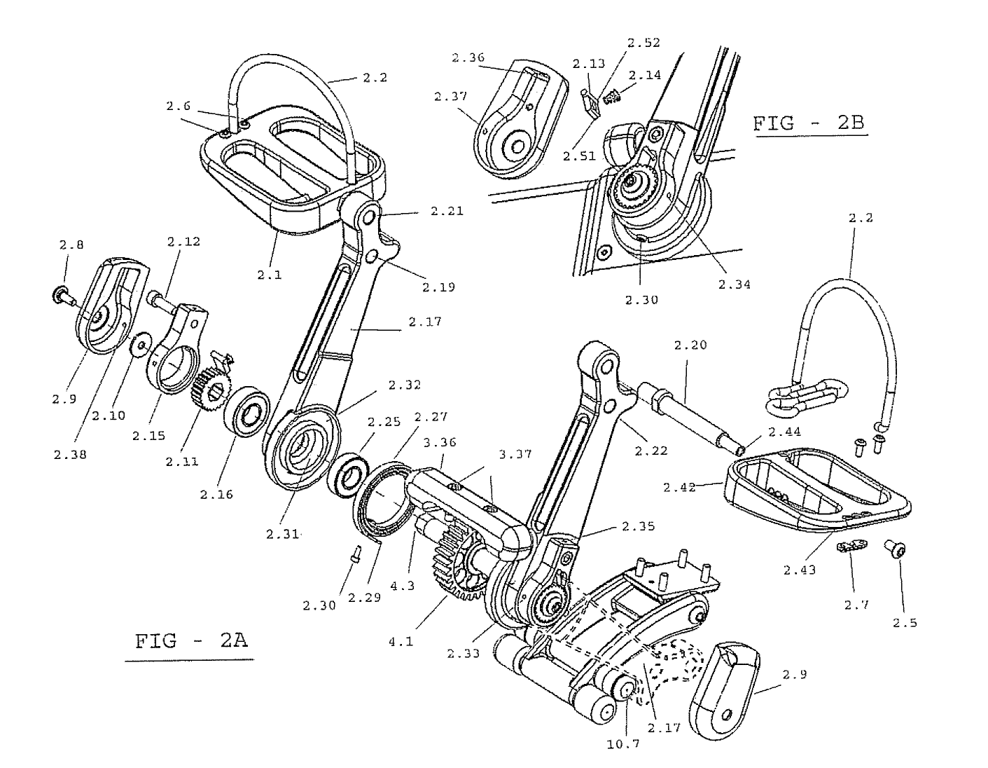

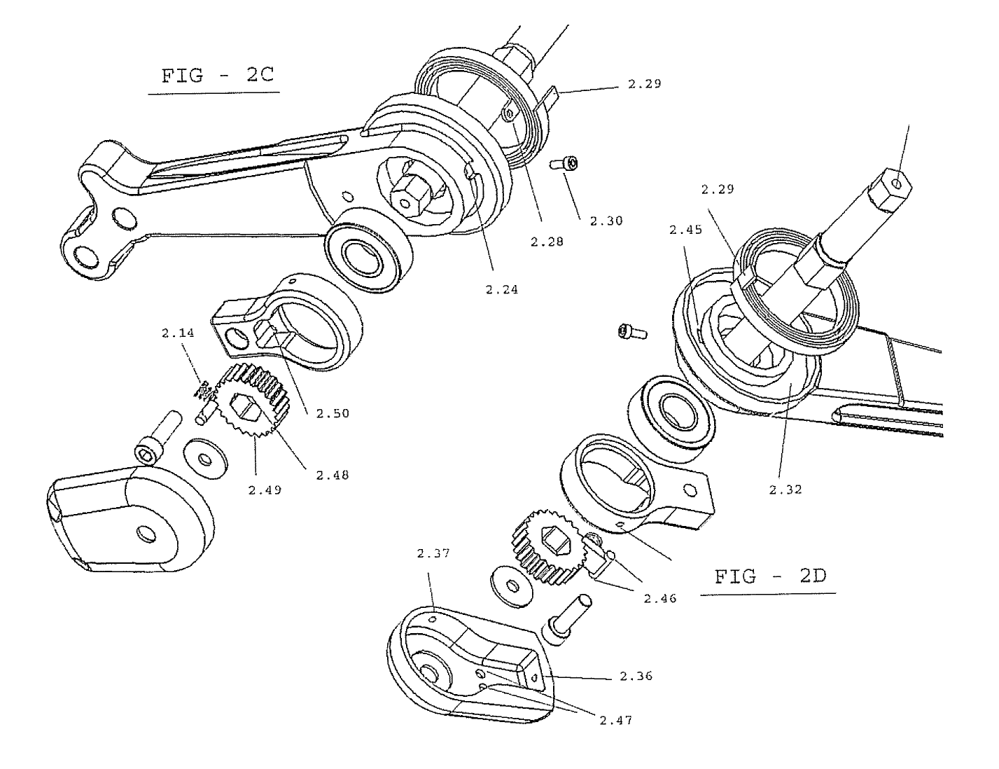

More specifically, the feature of a reciprocating pedal-arm assembly that includes a pedal arm constructed from a lightweight material such as, but not limited to, polymers, molded plastics, fiber reinforced plastics, carbon fiber composites, aluminum, light metal alloys, and a ratchet housing that is constructed from a hard material such as, but not limited to, cast iron and steel, will be discussed with regard to FIGS. 2-2D.

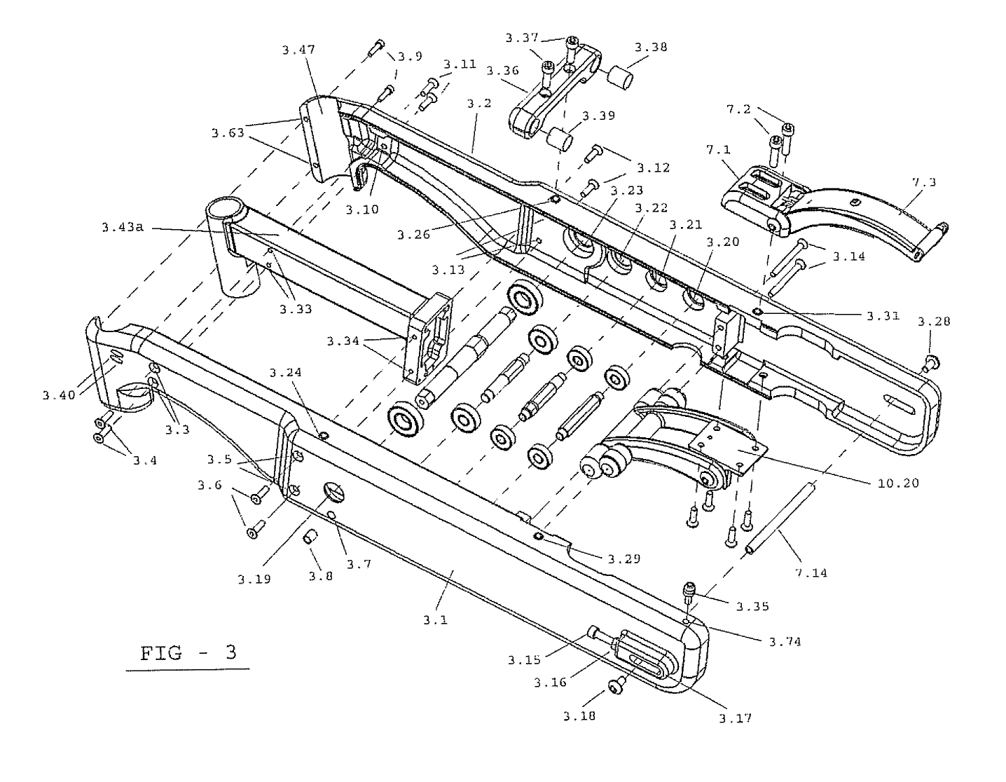

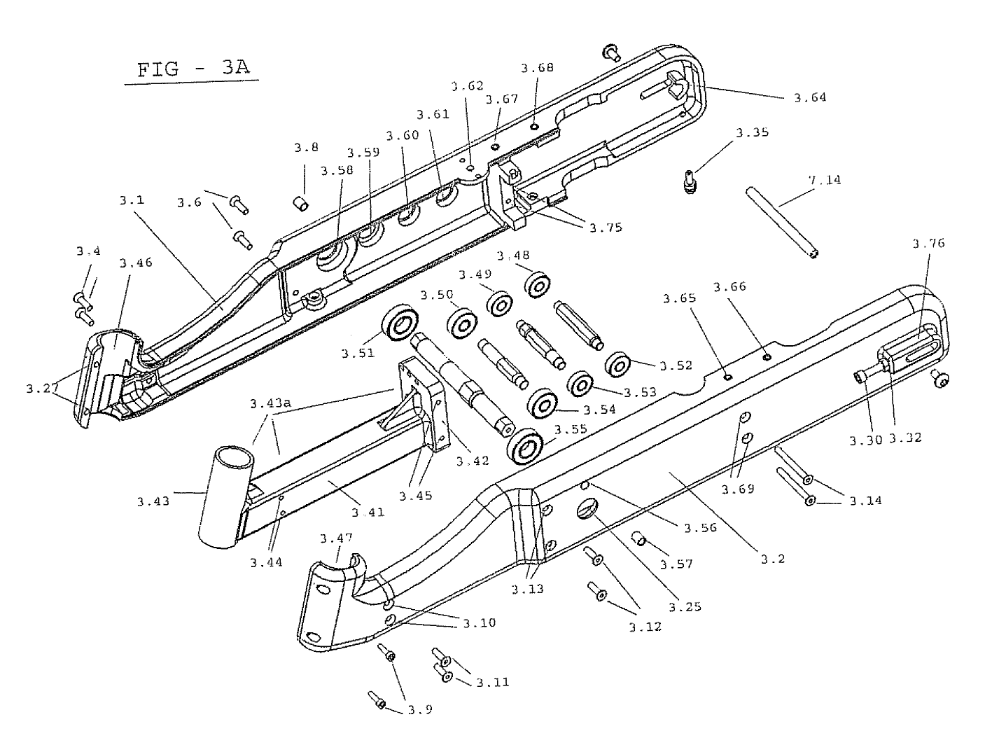

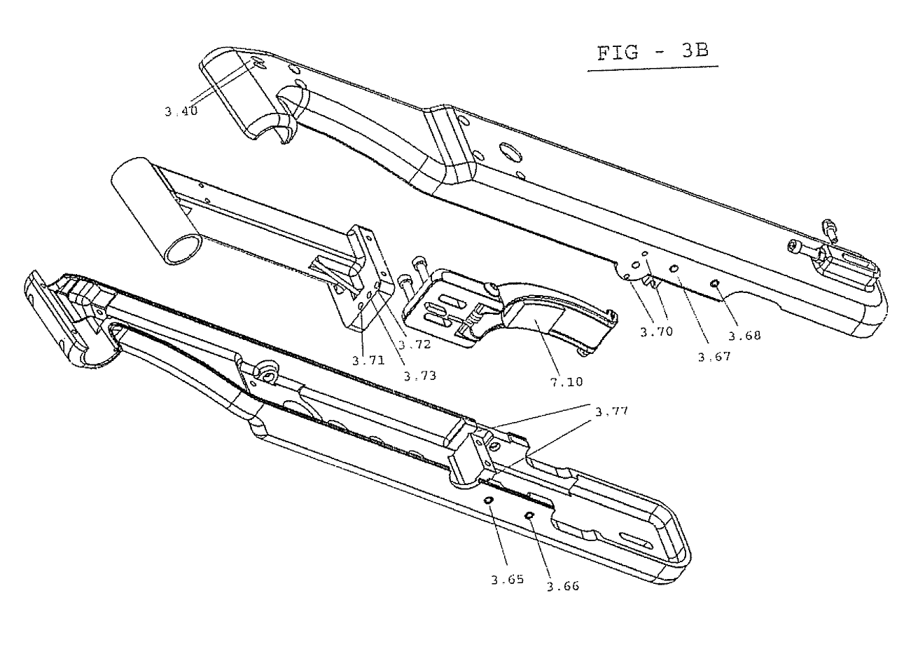

The feature of a molded body having at least one integrally molded attachment arrangement configured for the attachment of at least one vehicle component will be discussed with regard to FIGS. 3-3B. It should be noted that the term “body” is used herein to refer to the substantially horizontal load-bearing element of the vehicle. It will be appreciated that the term “molded” is preferably used herein to refer to injection-molded plastics. However, substantially any molding process such as, but not limited to, hand laid or chopped fiber reinforced plastics, and vacuum formed should be considered to be within the scope of the present invention. As used herein, the term “integrally molded attachment arrangement” refers to substantially any arrangement that is integrally molded into the body, or a body panel, at the time of initial molding, such arrangement being usable for the attachment of a vehicle component such as, but not limited to, wheel axles, brake mechanisms, cables, gears, bearings, shafts, and the like.

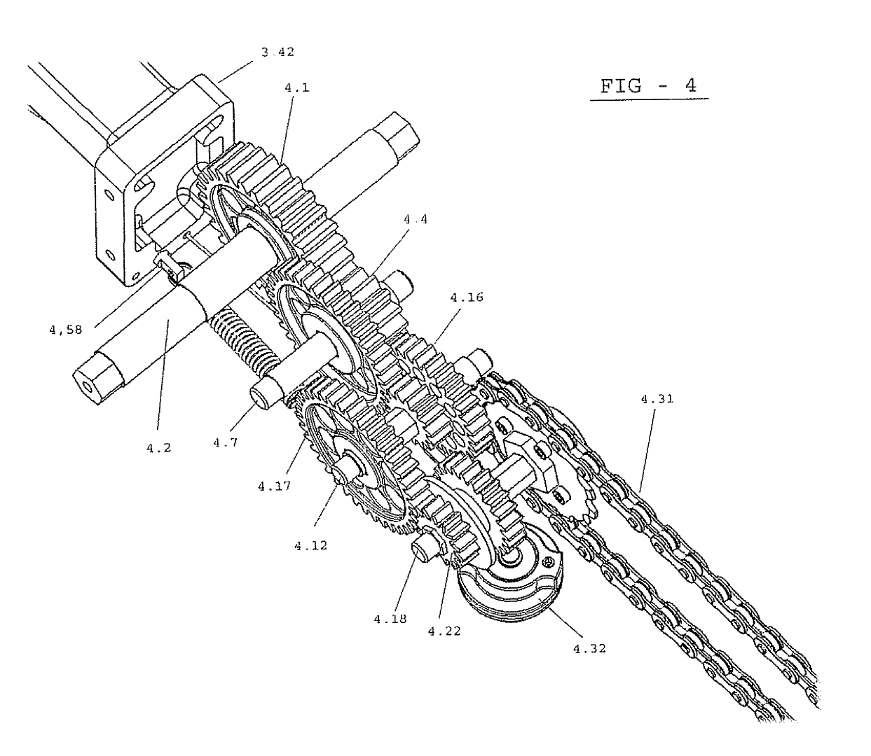

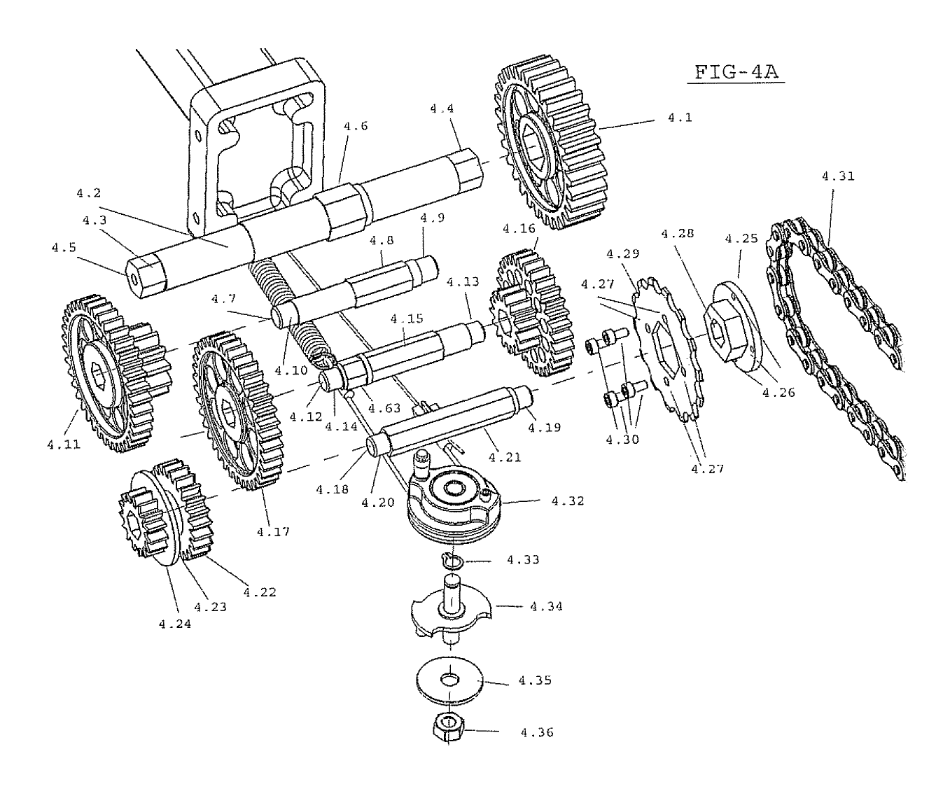

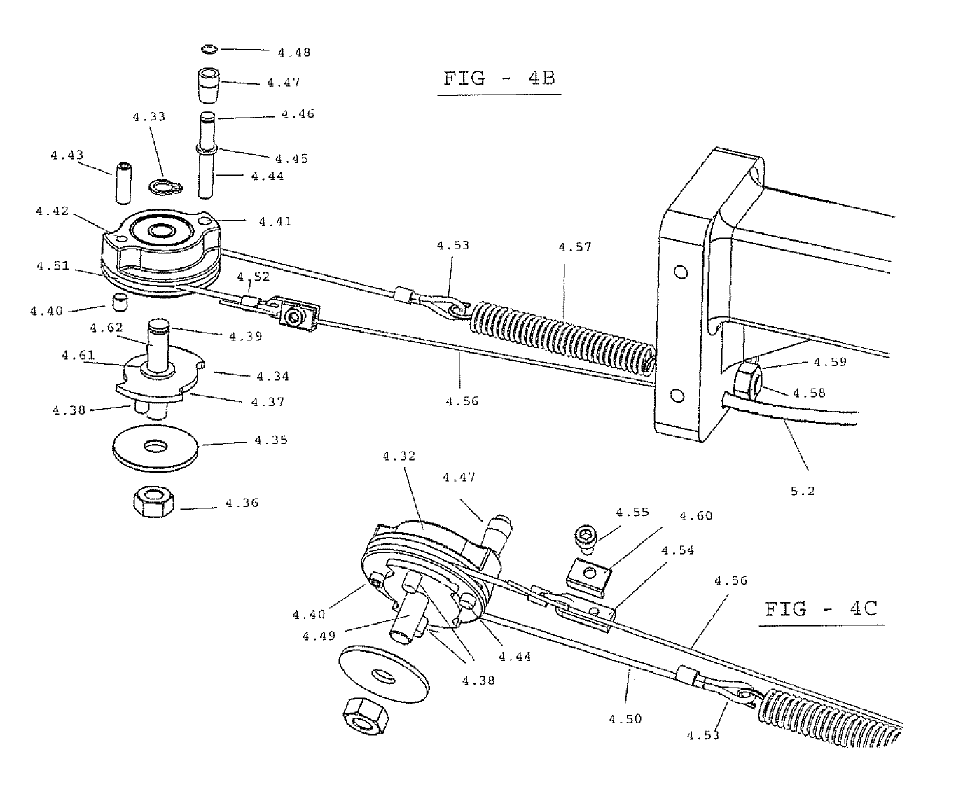

The feature of a shiftable transmission that is integral to the vehicle body will be discussed with regard to FIGS. 4-4C.

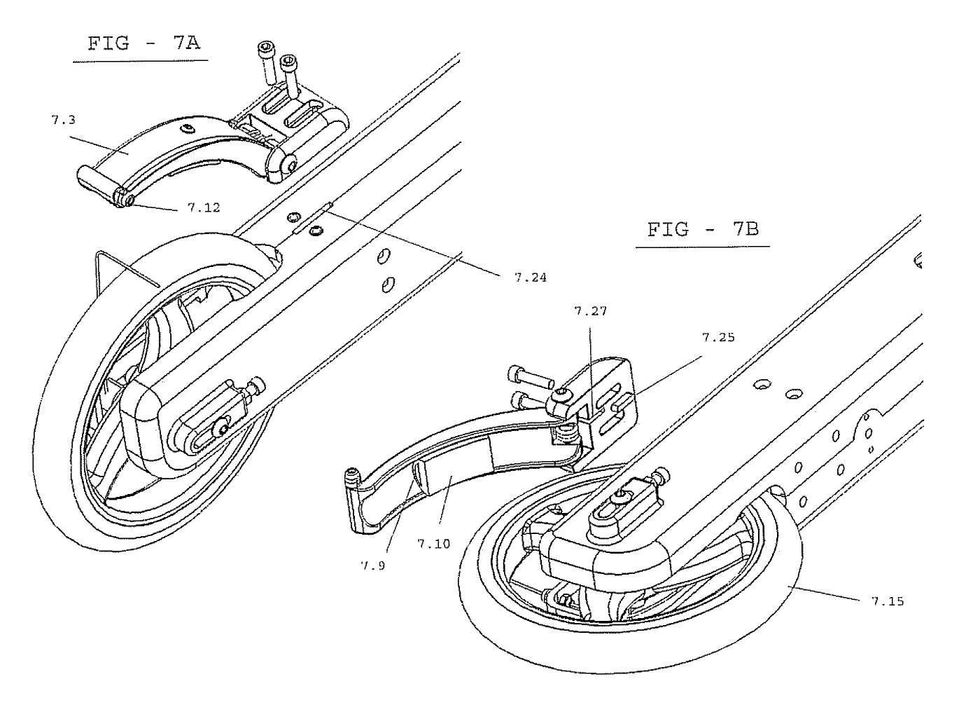

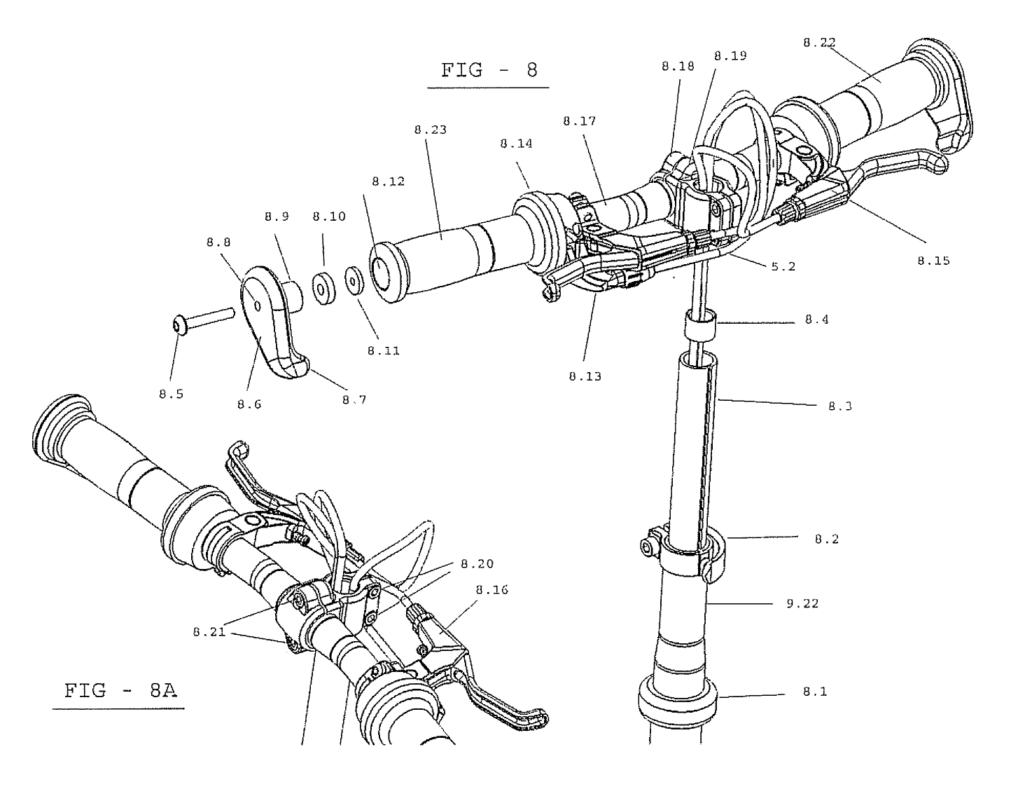

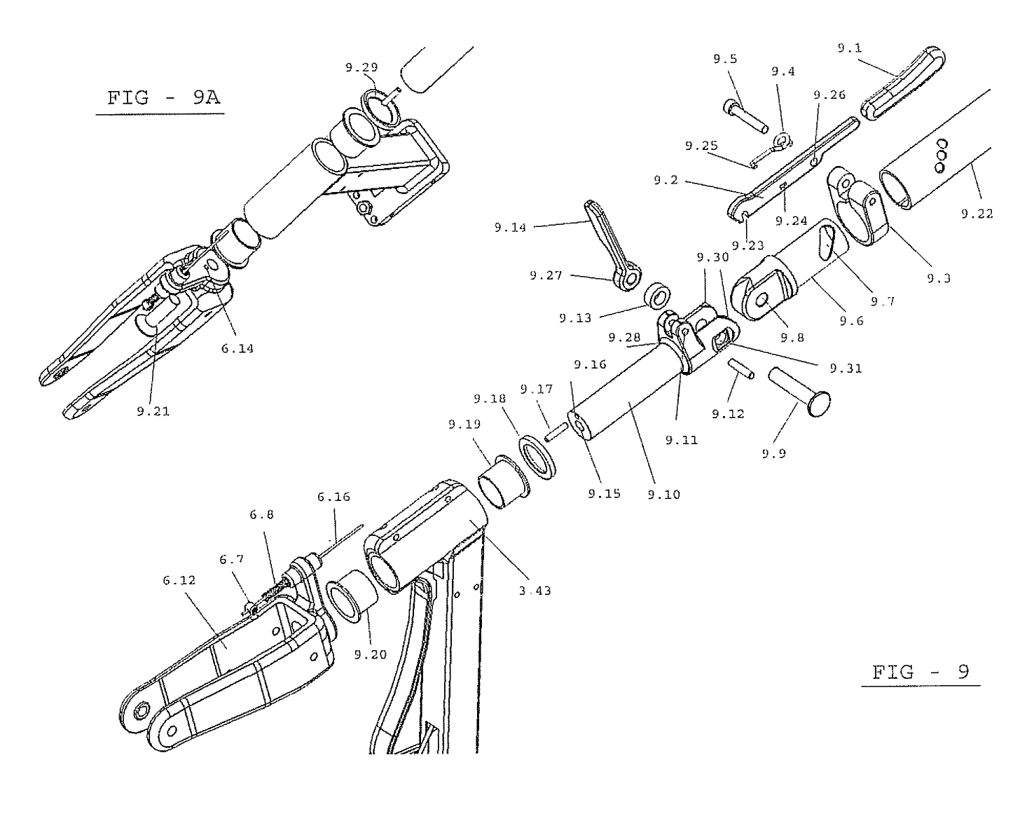

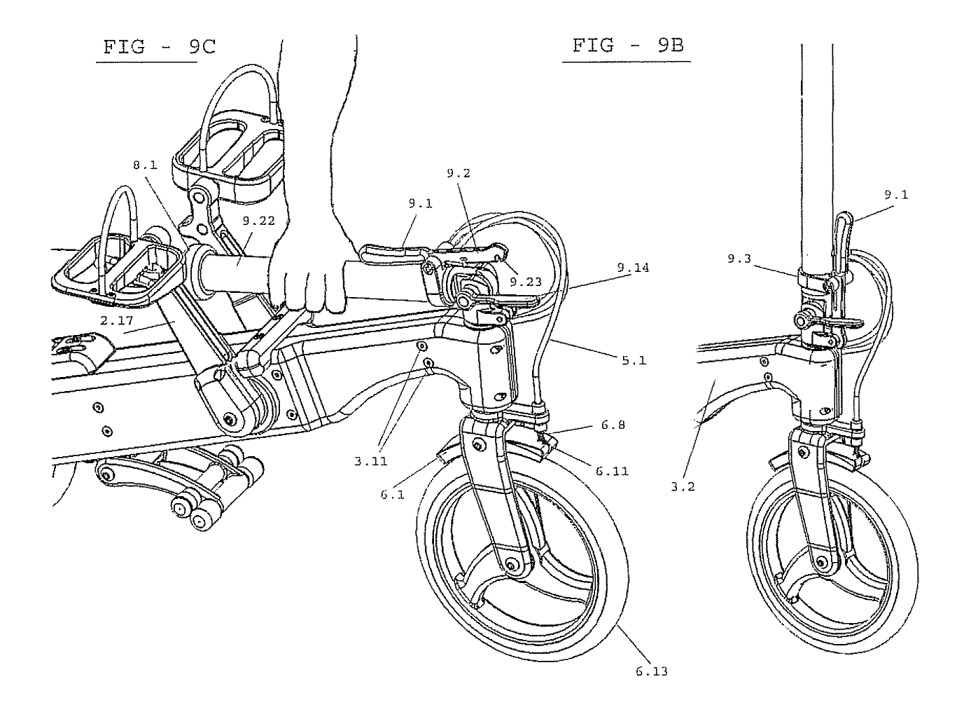

The several features of the steering column of the present invention will be discussed with regard to FIGS. 8-9C.

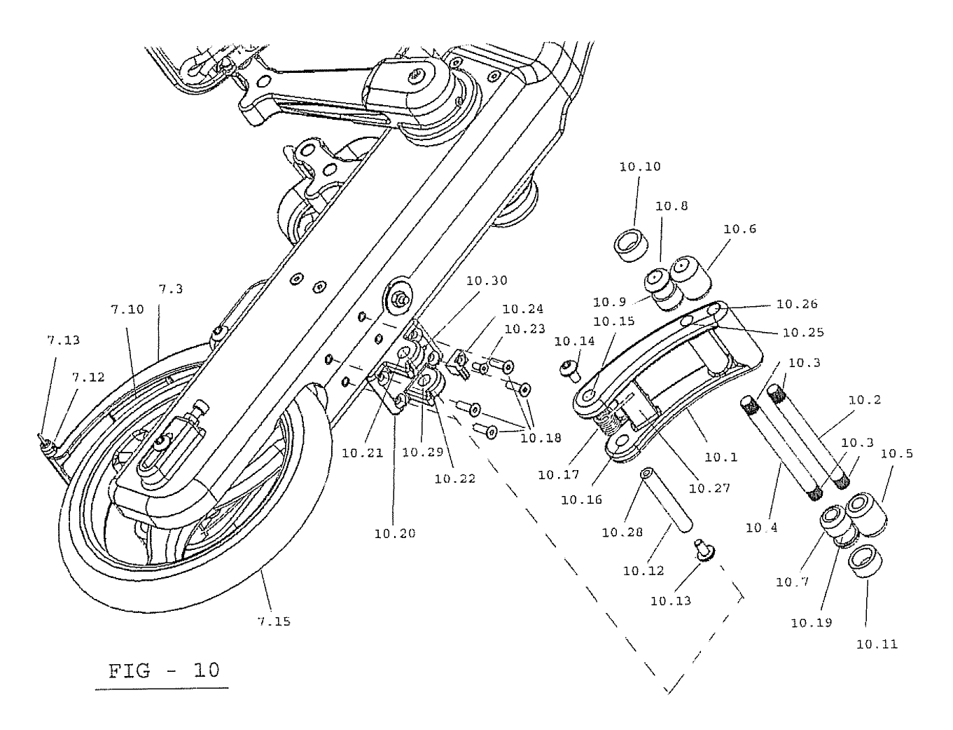

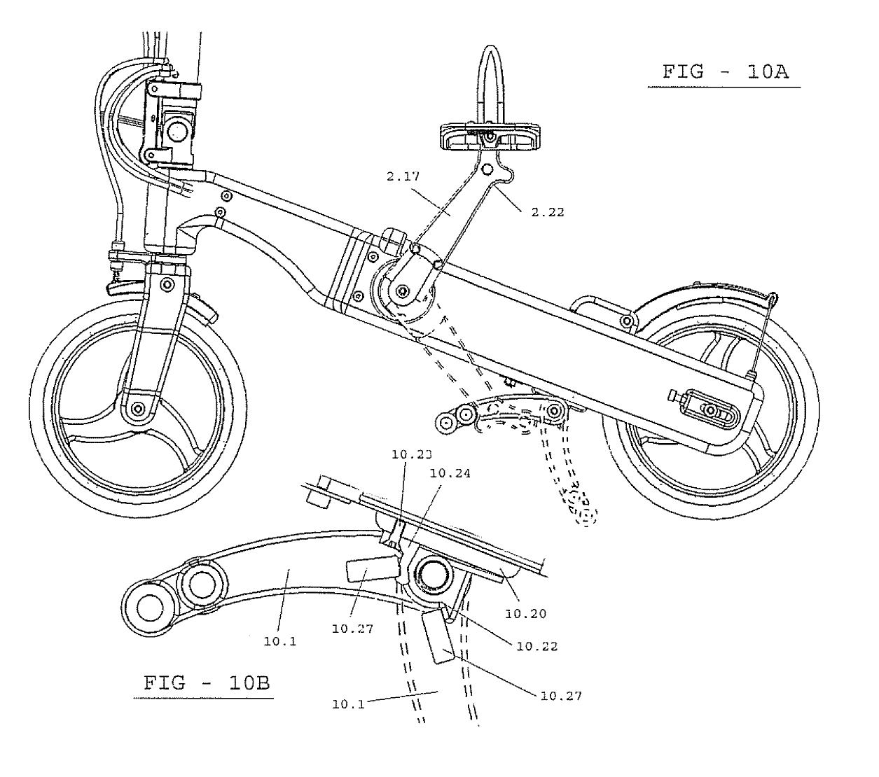

The features of the kickstand which serves as a combination vehicle support when the scooter is not in use and pedal down-stroke stop when a rider is pedaling the scooter will be discussed with regard to FIGS. 10-10B. The term “pedal down-stroke stop” is used herein with regard to the element that defines the end point of the downward motion of the pedal during a downward pedaling stoke.

When combined in a two-wheel pedal powered scooter, they provide a vehicle that is small and compact. The reciprocating pedals allow for a low center of gravity since there is no need to allow for the full turn of regular pedals. Preferably, the rotation of the pedals is limited to a range that is less than 160°, and preferably about 120°. The incorporation of a shiftable transmission in the scooter body provides the rider with speed when appropriate and power when needed, while eliminating the need for a large front sprocket like those used in standard bicycles. Since the drive mechanism is substantially fully enclosed by the body of the scooter, there is less of a problem with dirt and debris disturbing the operation of the drive mechanism. The unique steering column provides hidden cables and adjustable steering column angle, among other features that will be discussed below. As used herein, the term “steering column angle” refers to the angle of the upper, adjustable, portion of the steering column in relation to the head tube of the scooter. It should be noted that the term “cable” is used herein to refer either to a combination of a cable host in which a cable is deployed or to the bare cable alone.

It should be noted that the configuration of the pedals so as to rotate about the pedal crank shaft in a rearward downward direction serves to increase the efficiency of the rider's application of power to the drive mechanism of the scooter. This is due in part to the fact that the forward inertia of the scooter shifts the rider's weight back and therefore against the pedals in the direction of the power stroke of the pedals. Furthermore, the pedals may be operated separately or in combination to power the vehicle.

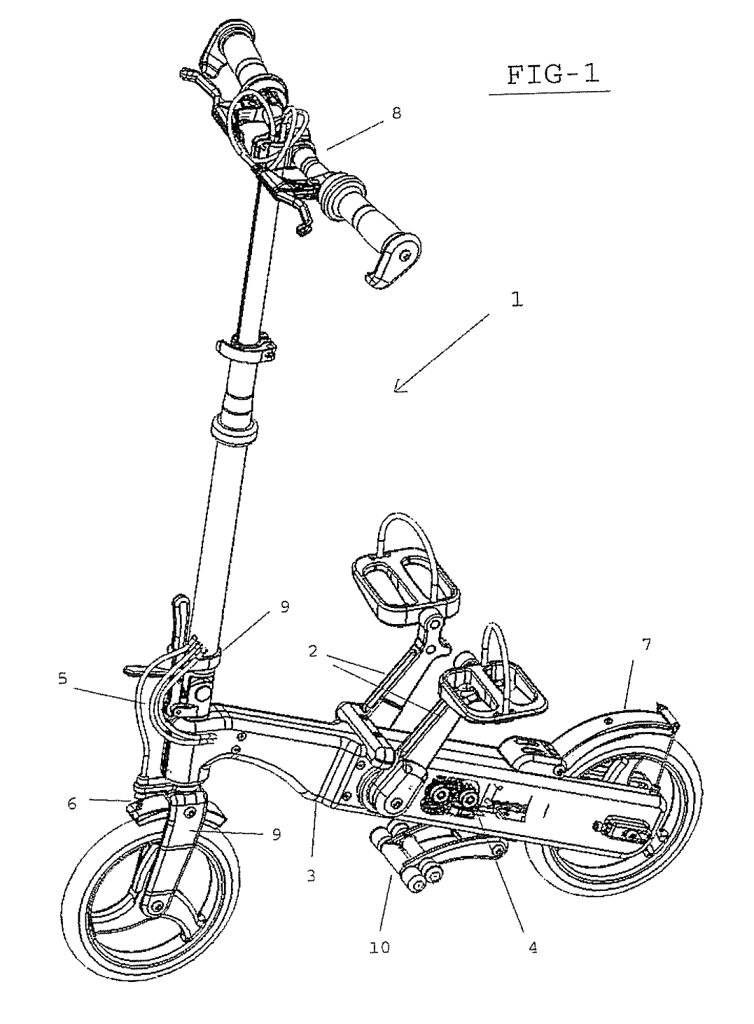

### FIG. 1

Referring now to the drawings, FIG. 1 provides an overall view of a two-wheel scooter 1 incorporating the features of the present invention. By general reference, illustrated in FIG. 1 are the reciprocating pedal assembly 2, vehicle body 3, geared transmission 4, cables for the transmission gear shifting mechanism and for the front and rear brakes 5, the front brake and the front wheel 6, the rear brake and the rear wheel 7, the handlebar 8, the steering column 9, and the kickstand 10.

### FIGS. 2, 2A, 2B, 2C and 2D

FIGS. 2-2d illustrate the reciprocating pedal assembly. Since the two corresponding pedal assemblies are symmetrical, the same reference numerals may be used in relation to corresponding elements in each of the pedal assemblies The pedals are operated by the rider's legs applying force to the pedals 2.1, in a downwards step like movement. The pedal arm 2.17 rotates about the pedal crank shaft 4.2. The downward movement is stopped by the pedal down-stroke stop element 10.7 or 10.8, which is part of the kickstand mechanism (see FIG. 10). The pedal arms 2.17 are supported on the crank shaft 4.2 by bearings 2.25 and 2.16 that are deployed inside 2 the bearing sockets 2.23 and 2.31 configured on each side of the pedal arm 2.17. The crank shaft 4.2 traverses the body 3 and is mounted to the body by bearings 3.51 and 3.55 that are deployed inside the fitted bearing sockets 3.25 and 3.58 configured in the inside surface of each of the corresponding body panels 3.1 and 3.2. Attached to each of the pedal arms is a one way ratchet mechanism 2.11 which is deployed in the ratchet housing 2.15. Because of the ratchet mechanism, when the pedal arm 2.17 and thereby the ratchet housing 2.15 are rotated downward in a power stroke, the crank shaft 4.2 and drive gear 4.1 also rotate, thereby supplying power to the transmission 4. The pedal arms 2.17 are biased by a flat spiral spring 2.28 to an upward home position as illustrated by the position of the pedals 2 in FIG. 1. Therefore, when the rider removes the force being applied to the pedals, the pedals return to the initial home position where they are stopped by the upper pedal stops 3.38 and 3.39 (see FIG. 3). Because of the ratchet mechanism 2.11 the upward movement of the pedal arms does not rotate the crank shaft 4.2.

The ratchet mechanism 2.11 and the ratchet housing 2.15 are constructed from a hard material such as, but not limited to, steel or cast iron. This allows for the pedal arm to be constructed of a lighter material as mentioned above. This configuration provides a hard ware-resistant drive mechanism operated by a lightweight pedal assembly. It is noteworthy that the ratchet housing cover 2.9 is configured so as to be interchangeable from one side to the other. This simplifies both manufacture and assembly procedures for the reciprocating pedal assembly of the present invention.

The spring 2.27 that bias the pedal arm 2.17 upwards to its home position is preferably a flat spiral spring that is deployed within a recess 2.32, which is configured in the pedal arm 2.17. The recess 2.32 is configured in the pedal arm 2.17 adjacent to the body 3 so as to circumscribe the pedal crank shaft 4.2. The recess 2.32 serves to both prevent the spring 2.27 from becoming twisted during use and also as a cover to prevent dust and dirt from damaging the springy 2.27. The flat spiral spring 2.27 is configured with two attachment tabs 2.28 and 2.29, one configured at each end of the spring and each of the 5 attachment tabs extends laterally from an opposite side of the flat spiral spring Thusly configured, attachment tab 2.28 is attached to the pedal arm 2.17 by inserting it through slit 2.45 and it is fastened in place by a screw 2.30 that threads into screw hole 2.24 Depending on which side of the body the pedal is deployed, attachment tab 2.29 is attached to the body 3 by inserting it into either of the steel rings 3.8 and 3.57 that are pressed into holes 3.7 and 3.56, respectively (see FIGS. 3 and 3a).

The pedal 2.1 rides on shaft 2.20 that may be screwed onto the pedal arm 2.30 using threaded hole 2.21 or threaded hole 2.19 whichever the rider prefers.

The pedal 2.1 is design with a sloping bottom surface so as to slope upward toward the outer end 2.43 such that the outer end 2.43 is thinner than the base 2.45 of the pedal 2.1. This shape prevents the pedals from hitting the round during sharp turns.

The pedal of the present invention also includes an adjustable foot strap 2.2 that is inserted through hole 2.4 an is fixedly attached to the pedal 2.1. The other end of the adjustable strap 2.2 passes through hole 2.39. Any extra length of strap 2.53 is coiled and pressed into friction fit notches 2.3 configured in the bottom surface of the pedal 2.1. This enables the rider to quickly and easily adjust the length of the strap 2.2 without the use of any tools.

### FIGS. 3, 3A and 3B

Turning now to the body of the scooter as illustrated in FIGS. 3-3B. Preferably, the body 3 is configured from two body panels 3.1 and 3.2 that connect to each other by screws. Two screws 3.14 pass through two holes 3.69 in the right side body panel 3.2 and screw in two threaded holes 3.75 in the left side body 3.1. Two other screws 3.9 pass through holes 3.63 in the right side body 3.2 and screw in two threaded holes 3.27 in the left side body 3.1.

Inside the body, a metal reinforcing member 3.43a that includes the head tube 3.43, a neck bar 3.41 and a rear plate 3.42 is installed for reinforcement and to reduce the flexibility of the plastic body 3.1. The metal reinforcing member 3.43a is connected to the two body panels 3.1 and 3.2 by screws 3.6, 3.4, 3.12 and 3.11 that pass through holes 3.3, 3.5, 3.10 and 3.13 and are screwed into threaded holes 3.33, 3.34, 3.44 and 3.45.

Each the two body panels 3.1 and 3.2 is configured with integrally formed sockets configured for receiving the bearings upon which the gear cluster shafts are mounted. Configured in the right side body panel 3.2 are bearing sockets 3.20, 3.21, 3.22, 3.23 into which are deployed bearings 3.48, 3.49, 3.50, 3.51. The bearing sockets 3.61, 3.60, 3.59, 3.58, configured in left body panel 3.1 receive bearings 3.48, 3.49, 3.50, 3.51. These eight bearings candy the four shafts 4.2, 4.7, 4.12, 4.18 of the transmission 4 (see FIG. 4).

Connected to the top of the body 3 is a crossbar 3.36 that is connected to the body and houses the upper pedal stops 3.38 and 3.39. The crossbar 3.36 is connected to the body 3 by two screws 3.37 that screw into threaded holes 3.24 and 3.26 in the body.

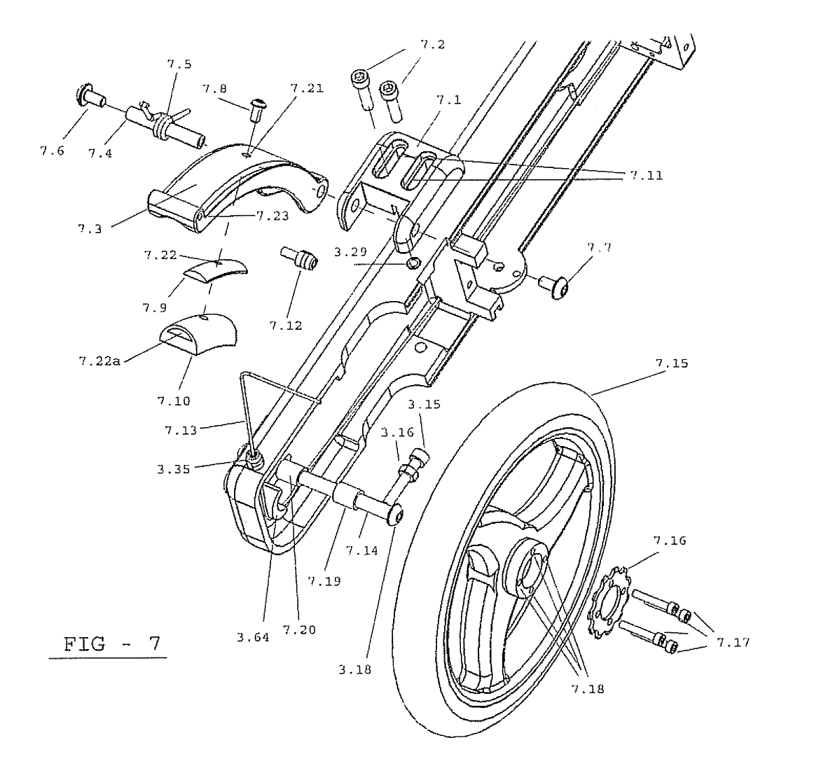

Configured near the rear of each of the body panels 3.1 and 3.2 is an adjustable axle mount 3.17 and 3.76 configured to adjust the position of the position adjustable axle 7.14 so as to maintain chain tension of the drive chain 4.31 (see FIG. 4) that supplies power to the drive-wheel 7.15 (see FIG. 7). Each of the adjustable axle mounts 3.17 and 3.76 includes an elongated slit that allows longitudinal movement of the axle 7.14 and the adjusting screws 3.15 and 3.30 serve to establish the longitudinal position of the axle 7.14. Locking of the adjusting screws 3.15 and 3.30 is achieved by two nuts 3.16 and 3.32 that fasten to the side of the axle mounts 3.17 and 3.76. Once positioned, the axle 7.14 is locked in place by axle lock screws 3.18 and 3.28, which screw into the ends of axle 7.14.

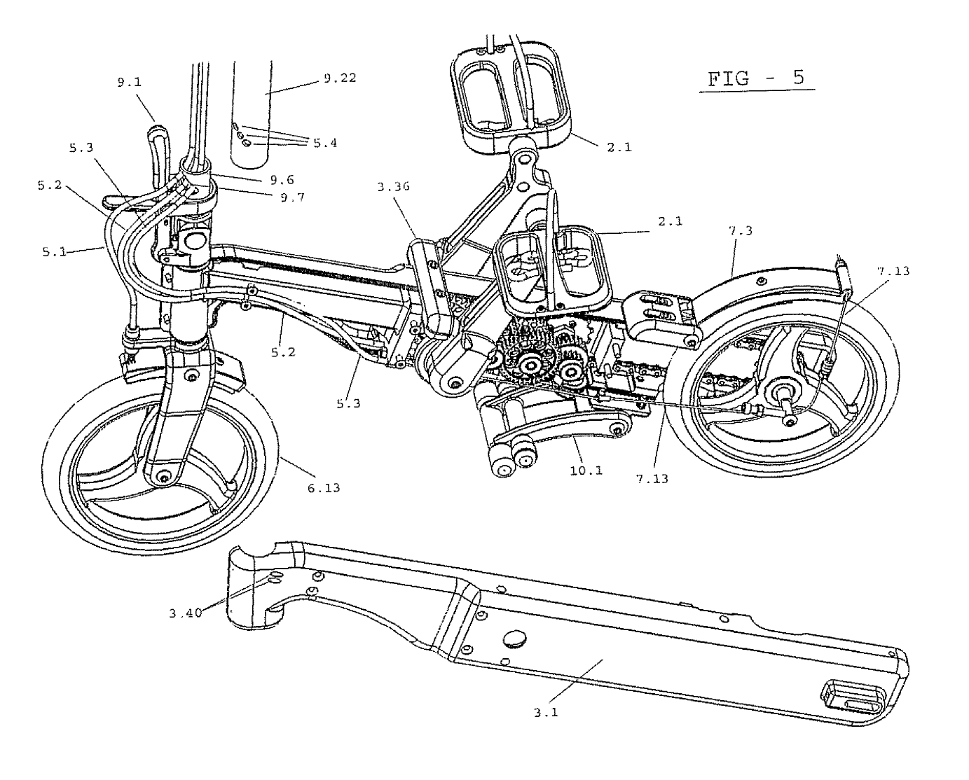

The left body panel 3.1 also includes two holes 3.40 through which pass cables 5.2 and 5.3. Cable 5.2 (see FIG. 5) runs to the gear-shifter mechanism 4.32 (see FIG. 4) and cable 5.3 runs to the rear brake 7.3. These two cables continue through the inside of the hollow steering column 9.22 to their respective levers deployed on the handlebar 8.17 as will be discussed below.

The two body parts 3.1 and 3.2 are configured in a way that the transmission 4 is closed from all sides except two holes 3.77 through which the chain 4.31 (see FIG. 4) passes. The purpose for enclosing the transmission 4 is to prevent dirt and dust from entering the transmission 4.

### FIGS. 4, 4A, 4B, and 4C

Referring now to the geared transmission mechanism 4 as illustrated in FIGS. 4-4C. The crank shaft 4.2 that is driven by the pedals carries gear 4.1, which in turn delivers rotational motion to the geared transmission 4. The purpose of the geared transmission is to increase the slow rotational speed of the pedal crank shaft 4.2 to the faster rotational speed needed to drive the rear wheel 7.15 (see FIG. 7) and thereby, effect forward vehicle locomotion. As is typical of geared transmissions, rotation of gear 4.1 generates rotation of double-gear 4.11, which is mounted on the shaft 4.7. Double-gear 4.11 in turn generates rotation of double-gear 4.16, which is mounted on another shaft 4.12, and thus also rotation of gear 4.17.

Preferably, the transmission of the present invention includes a gear shifting mechanism so as to provide two-speed gear shifting It should be noted that embodiments having more than two gear ratios is within the scope of the present invention. The rotational motion is transferred to shaft 4.18 and thereby to the transmission chain sprocket through one of two gear paths Low-speed gearing is provided when double-gear 4.22 meshes with double-gear 4.16. High-speed gearing is provided when double-gear 4.22 meshes with gear 4.17. Selection between these two gearing options is achieved by displacing double-gear 4.22 on shaft 4.18. Displacement of double-gear 4.22 to the desirable location on shaft 4.18, in order to change the speed, is effected by sleeve 4.47 that is free to rotate about pin 4.44 and therefore operates as a bearing when deployed inside the peripheral groove 4.23 configured in double-gear 4.22. Pin 4.44 extends from rotary base 4.32, rotation of which is activated by gear-shifter 8.14 that is deployed on handlebar 8.17 by means of cable 4.56, which extends from cable 5.2, that links gear-shifter 8.14 to rotary base 4.32. Therefore, rotation of base 4.32 effects displacement of double-gear 4.22 along the shaft 4.18.

As mentioned above, the four transmission shafts 4.2, 4.7, 4.12 and 4.18 are supported by bearings 3.48, 3.49, 3.50, 3.51, 3.52, 3.53, 3.54 and 3.55 that are mounted directly into sockets 3.20, 3.21, 3.22, 3.23, 3.58, 3.59, 3.60 and 3.61 (see FIG. 3A) that are integrally molded in the interior volume of the molded body that houses the geared transmission, thereby eliminating the need for a separate transmission case.

### FIG. 5

Turning now to FIG. 5 and the route of the cables 5.1, 5.2, 5.3 after they leave the steering column 9, all three cables exit the upper steering column 9.22 through holes 5.4 that are aligned with hole 9.7 configured in the upper handlebar folding-pivot section 9.6. Cables 5.2 and 5.3 continue into the vehicle body 3.1 through two holes 3.40 in a way that creates a loop between the point where they exit holes 5.4 and the point at which they enter the body 3.1 through holes 3.40. Cable 5.1 continues to the front brake mechanism. As mentioned above, cable 4.56 (see FIG. 4) that extends from cable 5.2 operates the gear-shifting, mechanism and therefore passes through hole 3.71 (see FIG. 3B) in rear plate 3.42 (see FIG. 3A). Cable 7.13 that extends from cable 5.3 operates the rear brake, and therefore passes through hole 3.72 (see FIG. 3B) in rear plate 3.42 and continues to the rear section of the vehicle body and turns upward riding on cable guide 3.64 that is integrally molded into the body panel 3.1 and exits from the body through a sleeve 3.35 (see FIG. 3A) on its way to the rear brake 7.3.

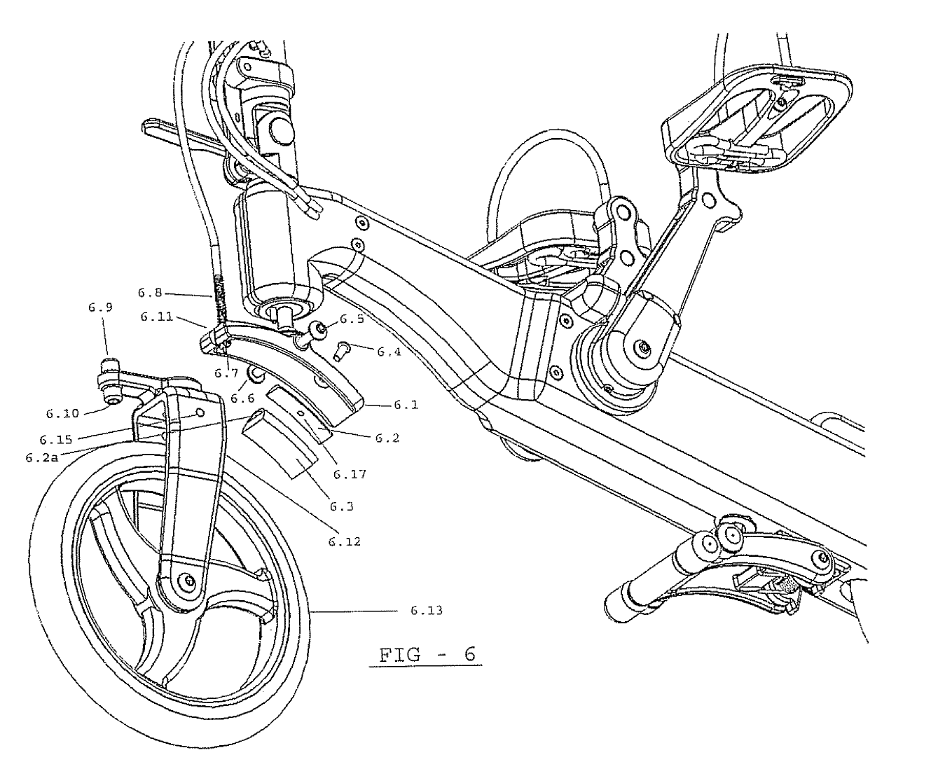

### FIG. 6

FIG. 6 illustrates the brake assembly 6 that is connected to the front fork 6.12 by two pass-through holes 6.15 such that front fender 6.1 rotates about screws 6.5 and 6.6. Rotation of the front fender 6.1 is effected by cable 6.16 that extends from cable 5.1. Cable 6.16 is attached to the front of front fender 6.1 and the brake pad 6.3 is attached to the rear of front fender 6.1. Therefore, when front fender 6.1 is rotated about screws 6.5 and 6.6 the brake pad 6.3 is forced against the front wheel 6.13.

The brake pad 6.3 is configured with a longitudinal passage 6.2a into which the brake pad attachment plate 6.2 is inserted. In this configuration, the brake pad 6.3 is connected to the fender 6.1 by a screw 6.4 that is screwed into a thread hole 6.17 in the brake pad attachment plate 6.2 deployed inside brake pad 6.3. This provides the present invention with a brake pad assembly that is easy to manufacture and assemble and easily chanced by the user when required.

### FIGS. 7, 7A and 7B

FIGS. 7, 7A and 7B illustrate the rear wheel and the rear brake assembly. The rear brake assembly is designed as a rear fender 7.3 above the rear wheel 7.15. Mounted on the underside of rear fender 7.3 is a brake pad 7.10 that is substantially identical to the front brake pad 6.3. The brake pad 7.10 is connected to the underside of the rear fender 7.3 by a screw 7.8 that passes through hole 7.21 and screws into threaded hole 7.22 configured in brake pad attachment plate 7.9 that is deployed within the longitudinal passage 7.22a formed in brake pad 7.10. The rear fender 7.3 is rotatably attached to a base 7.1, whose longitudinal position on the body 3 is adjustable. The rear fender 7.3 is rotatably attached to a base 7.1 by shaft 7.4 that is fixed in place by two screws 7.6 and 7.7 that screw into each of the ends of the shaft 7.4. The rear fender 7.3 is biased to an upward home position by a spring 7.5 that is deployed on shaft 7.4. One end of the spring is inserted into a slit 7.27 at the base 7.1 and the other end rests against the underside of the rear fender 7.3.

The braking operation is effected by pulling cable 7.13 that passes inside of the body 3.1 and is operated by the rear brake lever 8.16, which is mounted on the handlebar 8.17 (see FIGS. 8 and 8A). Cable 7.13 extends from cable 5.3 and passes through a hole 7.23 configured at the end of the rear fender 7.3, threaded into a sleeve 7.12 and fastened to the sleeve by a screw. The sleeve 7.12 is inserted and fixed inside the hole 7.23 in the rear fender 7.3. Pulling cable 7.13 causes the rear fender 7.3 to rotate downwardly about shaft 7.4 so as to bring the brake pad 7.10 into contact with the rear wheel in order to stop rotation of rear wheel 7.15.

The base 7.1 to which the rear fender 7.3 is connected, is attached to the body 3 by two screws 7.2 that pass through two slits 7.11. This allows adjustment of the longitudinal position of the rear fender 7.3. The adjustment of the position of the rear, fender 7.3 is necessary when the position of the rear wheel 7.15 is changed due to adjustment of the tension of chain 4.31 (see FIG. 4).

The rear wheel 7.15 rotates about shaft 7.14 that includes two spacing sleeves 7.19 configured to position the wheel 7.15 in the middle of the shaft 7.14.

### FIGS. 8 and 8A

As illustrated in FIGS. 8 and 8A, the handlebar 8.17 is connected to the substantially hollow steering column 8.3 by a handlebar attachment element having two sections 8.18 and 8.19. Section 8.19 is mounted to the steering column 8.3 so as circumscribe at least a portion, and preferably all, of the steering column 8.3. Section 8.19 is tightened around the top end of the steering column 8.3 by two screws 8.20. Deployed inside of the steering column 8.3, is a steel reinforcing element 8.4 that provides support to the steering column 8.3 in the region of the steering column 8.3 around which the handlebar attachment element is tightened. The reinforcing element allows the steering column 8.3 to be constructed from a lightweight material such as, but not limited to, fiber reinforced polymers, carbon fiber composites, aluminum, and light metal alloys, and the reinforcing element to be constructed from a hard material such as, but not limited to, cast iron and steel. In this configuration, an attachment region of the steering column 8.3 is sandwiched between the steel reinforcing element 8.4 and section 8.19 of the handlebar attachment element.

The upper end of the steering column 8.3 is open and an open passage is provided by the substantially hallow tube from which the steering column 8.3 is constructed. This allows the cables 5.1, 5.2 and 5.3 (see FIG. 5), which terminate at the two braking levers 8.15 and 8.16, and the gear-shifter lever 8.13, to enter the steering column 8.3.

The handlebar 8.17 is connected to the handlebar attachment element between sections 8.18 and 8.19, which are attached one to another by screws 8.21.

When adjusting the handlebar height, the spare length of the cables 5.1, 5.2 and 5.3 are free to move in and out of the steering column 8.3 as necessary.

The terminal ends of the handlebar 8.17 are configured with hand guards 8.6 that prevent the rider's hands from slipping off the handlebar 8.17. Preferably, the handlebar also includes cushioned handgrips 8.22 and 8.23. The hand guards 8.6 are configured with an integrally formed cylindrical extension 8.9 that is inserted into the hollow inside 8.12 of the handlebar 8.17. The hand guards 8.6 are attached to the handlebar 8.12 by tightening bolt 8.5 so as to draw nut 8.11 toward extension 8.9, which in turn deforms the rubber ring 8.10 deployed between them. The deformation causes the diameter of rubber ring 8.10 to increase, and thereby tighten to the interior surface of the handlebar 8.17, while still allowing rotation of the hand guards 8.6 around the axis of the cylindrical extension 8.9, allowing the rider to adjust the hand guards 8.6 to a convenient and comfortable angle,

### FIGS. 9, 9A, 9B and 9C

As shown in FIGS. 9-9C, the steering column is composed of two substantially hollow tubes 8.3 (see FIG. 8) and 9.22. Tube 8.3 is telescopically received within tube 9.22 in order to allow lengthening and shortening of the steering column. Tube 9.22 is mounted on the upper folding-pivot 9.6 by compression ring 9.3, which includes screw 9.5 that serves both as a shaft for locking lever 9.2 and to tighten compression ring 9.3 around tube 9.22. The lower folding-pivot 9.10 is inserted into, and rotates within, the head tube 3.43. The upper folding-pivot 9.6 is attached to the lower folding-pivot 9.10 by hinge pin 9.9 so as to allow rotation about an axis that is perpendicular to the longitudinal axis of the steering column and the head tube. Inside of the head tube 3.43 are deployed two bearings 9.19 and 9.20 that provide rotational support for the lower folding-pivot 9.10. Locking lever 9.2 serves to lock the rotation of interconnection of the folding-pivot 9.6 to the lower folding-pivot 9.10 so as to maintain the desired angle of alignment.

The angle of alignment of the steering column is determined by the location of the compression ring 9.3 along the steering column 9.22. Sliding compression ring 9.3 up or down steering column 9.22 changes the distance between compression ring 9.3 and the locking pin 9.11. Since the length of locking lever 9.2 is fixed, the attachment of locking lever 9.2 to locking pin 9.11 necessitates an adjustment in the angle of aliment between steering column 9.22 and the lower folding-pivot 9.10, and hence the head tube 3.43. Therefore, moving the compression ring 9.3 up the steering, column 9.22 brines the steering column 9.22 forward, and moving the compression ring 9.3 down the steering column 9.22 brings the steering column 9.22 rearwards. It should be noted that directional terms such as “up”, “down”, “forward” and “rearward” are used herein with regard to the directions as illustrated in the drawings and are not intended to limit the configuration of the present invention.

As illustrated in FIG. 9C, when the steering column 9.22 is folded in to a fully folded position, it may be used as a carry handle for the scooter of the present invention. When so deployed, the rubber cushion ring 8.1 protects the steering column 9.22 and pedal arms 2.17 from damaging each other.

### FIGS. 10, 10A and 10B

The kickstand 10, as illustrated in FIGS. 10-10Bb, selves as a combination vehicle support when the scooter is not in use and pedal down-stroke stop when the pedals are actuated. The kickstand body 10.1 is mounted on the kickstand base 10.20 by shaft 10.12, which passes through holes 10.21 and 10.29 configured in the base 10.20 and holes 10.15 and 10.16 configured in the kickstand. This attachment arrangement provides the kickstand body 10.1 rotational freedom about shaft 10.12. The kickstand body 10.1 is biased toward a raised position, as see in FIG. 10A, by spring 10.17.

In the raised position, the kickstand body 10.1 serves as the pedal down-stroke stop so as to define the end point of a down-stroke motion of the reciprocating-pedals 2.17. As shown in FIG. 10A, when a reciprocating pedal is actuated the curved contour 2.22 surface of the pedal arm strikes the pedal stop bumper 10.10 and the downward motion of the pedal is stopped. The pedal stop bumpers 10.10 are deployed in one of the peripheral grooves 10.9 and 10.19 configured in sleeves 10.7 and 10.8 that are mounted on either end of rod 10.4, which is deployed in hole 10.25 in the kickstand body 10.1.

Deployed in hole 10.26 is rod 10.2 that has mounted on its ends sleeves 10.5 and 10.6 that are configured for contacting the around when the kickstand is rotated to the vehicle support position illustrated by the broken lines in FIGS. 10A and 10B.

Downward rotation of the kickstand body into the vehicle support position is limited by tabs 10.22 that contact bracing element 10.27. For added support in the pedal down-stroke stop position, a latch 10.24 is connected to the kickstand base 10.20 by a screw 10.23. The latch 10.24 is also configured to engage bracing element 10.27.

It will be appreciated that the above descriptions are intended only to serve as examples and that many other embodiments are possible within the spirit and the scope of the present invention.

What is claimed is:

1. A pedal-powered vehicle comprising a molded body having at least one molded attachment arrangement such that said at least one molded attachment arrangement is integrally molded in said molded body, said attachment mechanism configured for the attachment of at least one vehicle component.

2. The pedal-powered vehicle of claim 1, wherein said molded body is configured as two molded sections that attach one to another.

3. The pedal-powered vehicle of claim 2, wherein said vehicle component is a geared transmission having gear-shaft bearings, said geared transmission configured to transmit power from vehicle pedals to a vehicle drive-wheel, and said at least one integrally formed attachment arrangement includes at least one socket integrally formed in each of said two molded sections, said sockets configured to receive said gear-shaft bearings

4. The pedal-powered vehicle of claim 3, further including at lease one reciprocating drive pedal configured to supply power to said geared transmission.

5. The pedal-powered vehicle of claim 4, wherein said at least one reciprocating drive pedal is configured as two reciprocating drive pedals, such that either both pedals cooperatively or each pedal separately supplies power to the geared transmission.

6. The pedal-powered vehicle of claim 1, wherein said vehicle component is a drive-wheel axle, and said at least one integrally formed attachment arrangement includes at least one adjustable axle mount configured to adjust a position of said axle and thereby adjust tension of a drive chain supplying power to said drive-wheel.

7. The pedal-powered vehicle of claim 1, further including a metal reinforcement element deployed within and fixedly attached to said molded body.

8. The pedal-powered vehicle of claim 7, wherein said metal reinforcement element includes a head tube configured to accept a steering column, thereby reinforcing the attachment of said steering column to said body.

9. The pedal-powered vehicle of claim 1, further including a position adjustable rear brake element adjustably attached to said body, a position of said position adjustable rear brake element being adjustable in relation to a vehicle rear wheel.

10. The pedal-powered vehicle of claim 1, further including at lease one reciprocating drive pedal configured to supply power to a vehicle drive-wheel.

11. The pedal-powered vehicle of claim 10, further including a kickstand displaceable between a vehicle support position and a pedal down-stroke stop position.

12. A pedal-powered vehicle comprising a molded body configured with an interior volume in which is housed a power transmission gear-cluster, and said molded body and said power transmission gear-cluster are both configured for direct attachment of said power transmission gear-cluster to said molded body, thereby eliminating a separate power-transmission casing

13. The pedal-powered vehicle of claim 12, wherein said molded body includes a plurality of sockets integrally formed within said molded body, said sockets configured to receive gear-shaft bearings of said power transmission gear-cluster.

14. The pedal-powered vehicle of claim 12, wherein said power transmission gear-cluster includes a gear change mechanism so as to provide shiftable multi-speed gearing.

15. A steering column capable of adjusting an angle of alignment between a longitudinal axis of the steering column and a longitudinal axis of a head tube supporting a portion of the steering column the steering column comprising:
(a) a lower section deployed within the head tube such that a longitudinal axis of said lower section is substantially parallel to the longitudinal axis of the head tube;
(b) an upper section rotatably interconnected to said lower section, said rotation being about an axis that is substantially perpendicular to the longitudinal axis of the steering column, thereby allowing adjustment of an angle of alignment between said upper section and said lower section, and thereby an angle of alignment between said upper section and the head tube; and
(c) a locking mechanism configured to lock rotation of interconnection of said upper steering section to said lower steering section so as to maintain a desired angle of alignment

16. The steering column of claim 15, wherein said locking mechanism includes:
(a) a slideable positioning element deployed on said upper steering section;
(b) a locking catch deployed on said lower steering section; and
(c) a locking, lever attached to said slideable positioning element and configured for releasable attachment to said locking catch;
wherein varying a distance between said slideable positioning element and said locking catch varies said angle of alignment between said upper section and the head tube when said locking lever is attached to said locking catch.

17. A combination vehicle support and pedal down-stroke stop for use with a reciprocating-pedal powered vehicle, the combination vehicle support and pedal down-stroke stop comprising a vehicle support structure attached to a vehicle body so as to be displaceable between a vehicle support position, in which the reciprocating-pedal powered vehicle is at least partially supported while at rest, and a pedal down-stroke stop position, which defines an end point of a down-stroke motion of at least one reciprocating-pedal.

18. The combination vehicle support and pedal down-stroke stop of claim 17, wherein said vehicle support structure includes at least one cushioned pedal-stop element that extends beyond a lateral side of said vehicle body.

19. The combination vehicle support and pedal down-stroke stop of claim 17, wherein said vehicle support structure includes two cushioned pedal-stop elements such that each said cushioned pedal-stop element extends beyond a different lateral side of said vehicle body so as to block said down-stroke motion of two reciprocating-pedals.

20. A reciprocating pedal-arm assembly comprising;
(a) a crank shaft;
(b) a pedal arm having a pedal end and crank end, said pedal end having at least one through bore for attachment of a pedal, and said crank end having a through bore configured for through passage of at least an end portion of said crank shaft;
(c) a ratchet mechanism deployed within a ratchet housing, said ratchet housing attached to said pedal arm such that said end portion of said crank shaft engages said ratchet mechanism;
wherein said pedal arm and said ratchet housing rotate about said crank shaft and said ratchet housing is constructed from a material harder than said pedal arms.

21. The reciprocating pedal-arm assembly of claim 20, wherein said pedal arm is constructed from at least one of the materials chosen from a list including polymers, molded plastics, fiber reinforced plastics, carbon fiber composites, aluminum, and light metal alloys, and said ratchet housing is constructed from at least one of the materials chosen from a list including cast iron and steel

22. The reciprocating pedal-arm assembly of claim 20, wherein said crank end of said pedal arm is configured to receive at least one bearing assembly such that said crank shaft passes through said at least one bearing assembly and said pedal arm is supported on said crank shaft by said bearing assembly.

23. The reciprocating pedal-arm assembly of claim 20, further including at least one flat spiral spring configured to bias said pedal arm toward an upraised pedal home position.

24. The reciprocating pedal-arm assembly of claim 23, wherein said at least one flat spiral spring has two attachment tabs, one configured at each end of said flat spiral spring and each said attachment tab extends laterally from an opposite side of said flat spiral spring.

25. A steering column assembly comprising:
(a) a substantially hollow steering-column tube that is open at both top and bottom ends with an open passageway therebetween, said steering-column tube having an internal cross-sectional contour;
(b) a handlebar attachment element for rigidly attaching handlebars to said steering-column tube, said handlebar attachment configured to circumscribe at least an attachment region of said steering-column tube and tighten there around; and
(c) a reinforcing element having an external cross-sectional contour substantially equivalent to said internal cross sectional contour of said steering-column tube, said reinforcing element deployed inside said steering-column tube so as to internally correspond to said attachment region such that said attachment region is positioned between said reinforcing element and said handlebar attachment element so as to provided support to said portion of said steering column tube when said handlebar attachment element is tightened there around while allowing said open passageway to remain open.

26. The steering column assembly of claim 25, wherein said reinforcing element is constructed from a material harder than said steering column tube.

27. The steering column assembly of claim 26, wherein said steering column tube is constructed from at least one material chosen from a list including fiber reinforced polymers, carbon fiber composites, aluminum, and light metal alloys, and said reinforcing element is constructed from at least one of the materials chosen from a list including cast iron and steel.

28. The steering column assembly of claim 25, wherein a length of at least one accessory cable passes through said open passageway.

29. The steering column assembly of claim 28, wherein said at least one accessory cable passes through a through bore configured in a side wall of said steering column tube in proximity to said bottom end of said steering column tube.

30. The steering column assembly of claim 29, wherein said at least one accessory cable passes through a through bore configured in a body panel of a vehicle to which the steering column assembly is attached.
